(19) United States
(12) Patent Application Publication
(10) Pub. No.: US 2018/0316953 A1
(43) Pub. Date: Nov. 1, 2018

(54) INTEGRATING MEDIA CONTENT FOR LOCAL CHANNELS AND SUBSCRIPTION CHANNELS

(71) Applicant: Sony Interactive Entertainment LLC, San Mateo, CA (US)

(72) Inventors: Joel Freeman, San Mateo, CA (US); Alex Hwang, San Mateo, CA (US)

(21) Appl. No.: 15/582,074

(22) Filed: Apr. 28, 2017

(51) Int. Cl. H04N 21/2343; H04N 21/2187; H04N 21/643; H04N 21/438; H04N 21/4402; H04N 21/482; H04N 21/4363; H04N 21/61

(52) U.S. Cl. CPC H04N 21/234309; H04N 21/2187; H04N 21/643; H04N 21/6106; H04N 21/440218; H04N 21/4821; H04N 21/43637; H04N 21/4383

(57) ABSTRACT

An integrated media platform employs techniques for streaming local and subscriber content. These techniques include determining at least one local channel is available over an over-the-air (OTA) communication network, receiving subscriber content for at least one subscriber channel over a first communication network, providing metadata content for display by a client device, where the metadata content includes information for the at least one subscriber channel and the at least one local channel, receiving a request for local content associated with the at least one local channel, tuning a network interface (e.g., an antenna) to receive the local content over the OTA network, transcoding the local content into streaming content, and providing the local content to one or more client devices connected to a local access network (LAN).

### BACKGROUND OF THE INVENTION

### Field of the Invention

The present disclosure generally relates to streaming content over a communication network. More particularly, the present disclosure concerns integrating media content from multiple communication networks.

### Description of the Related Art

The Telecommunications Act of 1996 mandated conventional TV broadcasters to transition from analog broadcasting (National Television System Committee (NTSC) formats) to digital broadcasting (Advanced Television Systems Committee (ATSC) formats) and ushered in a new era for telecommunications networks as well as a convergence of telecommunication systems into a single broadband network. In addition to the legislative mandates, advances in network connectivity, speed, convenience, and the like, support an ever increasing community of online consumers who can access media content over networks, such as the Internet.

Indeed, more and more consumers watch movies or listen to music through their video and audio streaming devices, and many streaming service providers (e.g., PlayStation™ Vue, Netflix™, Hulu™, Roku™, etc.) offer online media content that competes with traditional cable TV service provider content. But licensing local content (e.g., local TV news, other local channels, etc.) by streaming service providers often proves complex and expensive.

Accordingly many streaming service providers do not offer local content. In turn, consumers who subscribe to and choose one streaming service provider amongst the multitude of competing service providers (in order to avoid expensive monthly service charges) also forego local content. Therefore, there is a need in the art for integrating different types media content, including local content and subscriber content.

### SUMMARY OF THE PRESENTLY CLAIMED INVENTION

In one exemplary embodiment, this disclosure provides a method for integrating local content and subscriber content, which are now described with respect to an integrated media device. The integrated media device performs steps or operations of the method including, for example, determining a local channel is available over an over-the-air (OTA) communication network and receiving subscriber content a subscriber channel over a first communication network. Often, the first communication network represents the Internet, which may be different than the OTA communication network. The integrated media device further provides metadata content for display by a client device, such as a mobile device, a tablet, a television, and the like. Notably, the metadata content includes information for the subscriber channel and the local channel such as titles, summaries, character cast, and the like. In addition, the integrated media device receives a request for local content associated with the local channel and tunes an antenna (e.g., one of its network interfaces) to receive the local content over the OTA network. The integrated media device also transcodes the local content into streaming content and provides the streaming content to one or more client devices connected to a local access (LAN) network such as a home WiFi network.

In another embodiment, an integrated media system employs techniques to integrate and stream local content and subscriber content. For example, the integrated media system includes a network interface to communicate over one or more communication networks, a processor coupled to the network interface and adapted to execute one or more processes, and a memory configured to store a process executable by the processor. The process (when executed by the processor) operates to determine a local channel is available over an over-the-air (OTA) communication network and also receive subscriber content a subscriber channel over a first communication network. Notably, in some aspects, the first communication network represents the Internet and is different than the OTA communication network. The process further operates to provide metadata content for display by a client device, such as a mobile device, a tablet, a television, and the like. Here, the metadata content includes information for the subscriber channel and the local channel. In addition, the process further operates to receive a request for local content associated with the local channel, and tune the network interface (e.g., an antenna) to receive the local content over the OTA network. The process further transcodes the local content into streaming content which is provided to one or more client devices connected to a local access (LAN) network such as a home WiFi network.

In yet another embodiment, a tangible, non-transitory, computer-readable media includes software or instructions to be executed by a processor. The processor executes the software and performs operations such as determining at least one local channel is available over an over-the-air (OTA) communication network and receiving subscriber content for at least one subscriber channel over a first communication network. Notably, the first communication network may be different than the OTA communication network, as discussed. The operations also include providing metadata content for display by a client device. Similar to the above discussed embodiments, the metadata content includes information for the at least one subscriber channel and the at least one local channel. In addition, the operations also include receiving a request for local content associated with the at least one local channel, tuning a network interface (e.g., an antenna) to receive the local content over the OTA network, transcoding the local content into streaming content, and providing the local content to one or more client devices connected to a local access (LAN) network.

As mentioned, the OTA communication network may be different than the first communication network. In such embodiments, the methods, systems, and computer-readable media include respective operations to receive the metadata over the first communication network and match the metadata content to the subscriber channel and the local channel (which local channel includes local content received over the OTA communication network).

### BRIEF DESCRIPTION OF THE DRAWINGS

FIG. 1 illustrates a schematic diagram of an example communication network;

FIG. 2 illustrates a block diagram of an example network device;

FIG. 3 illustrates a schematic diagram of an integrated media system;

FIG. 4 illustrates an exemplary signaling diagram for operations by the integrated media system shown in FIG. 3;

FIG. 5 illustrates a block diagram of an integrated media platform, according to another embodiment of this disclosure;

FIG. 6 illustrates a schematic diagram of an integrated media system, according to another embodiment of this disclosure;

FIG. 7 illustrates a schematic diagram of an integrated media system, according to another embodiment of this disclosure; and

FIG. 8 illustrates an example simplified procedure for integrating media streams, including local content and subscriber channel content.

### DETAILED DESCRIPTION

As used herein, the term “user” refers to a user of an electronic device(s) and actions performed by the user in the context of computer software shall be considered to be actions to provide an input to electronic device(s) to cause the electronic device to perform steps or operations embodied in computer software. As used herein, the terms “stream”, “content”, and/or “channel” generally refer to digital media data. As used herein, the terms “network” and “communication network” are synonymous and generally refer to a group of devices in communication with each other.

As discussed in greater herein, the subject disclosure relates to techniques for streaming content over a communication network, and more specifically, to integrating and streaming local media content and subscriber media content. For example, in one aspect of this disclosure, an integrated media device (e.g., or system, platform, etc.) determines at least one local channel is available over an over-the-air (OTA) communication network and receives subscriber content for at least one subscriber channel over a first communication network (e.g., the Internet). Notably, the first communication network supports over-the-top (OTT) content/providers of audio, video, and other media content. The integrated media device further provides metadata content for display by one or more client devices connected to a local access network (LAN). The metadata content can include, for example, information for the at least one subscriber channel as well as information for the at least one local channel. The integrated media device also receives a request (e.g., from one of the client devices) for local content associated with the at least one local channel and tunes a network interface (e.g., an antenna) to receive the local content over the OTA network. The integrated media device further transcodes the local content into streaming content (e.g., Advanced Video Coding data), and hosts, broadcasts, or otherwise provides the local content to one or more client devices connected to the local access network (LAN). These and other features are described in greater detail herein and with reference the drawings.

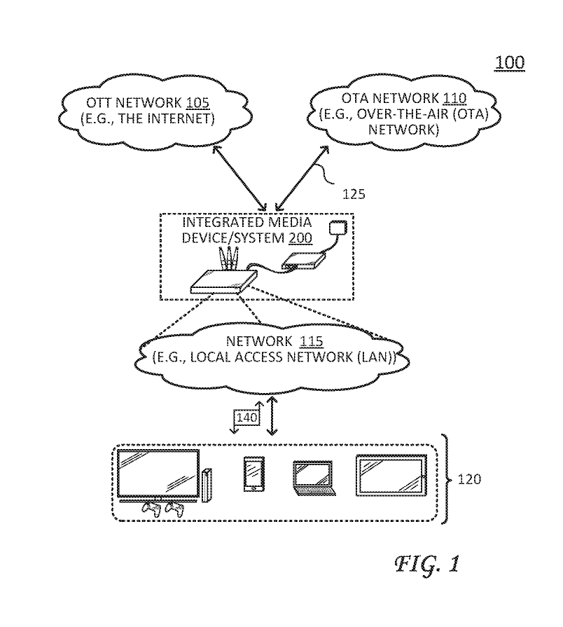

Referring to the figures, FIG. 1 illustrates a schematic diagram of an example communication network 100. As shown, communication network 100 includes a number of sub-networks, such as an over-the-top (OTT) network 105 (e.g., the Internet), an over-the-air (OTA) network 110, as well as a private network 115 (e.g., a local access network (LAN)). OTT network 105 generally represents a communication network such as a content delivery network (CDN) and supports OTT media content (e.g., subscriber content) over the Internet, OTA network 110 generally represents a wireless communication network for delivering over-the-air (OTA) programing, TV content, and the like, and private network 115 (also referred to as LAN 115), generally represents a private network that supports communications over dedicated communications links for devices located in the same general physical location, such as a home, building or campus. Collectively, the communication networks shown in FIG. 1 include a distributed collection of devices or nodes (not shown) and are interconnected by communication links 125 (and/or network segments) to exchange data such as data packets 140 and transport data between content providers and end nodes (e.g., client devices 120). Client devices 120, as shown, include personal computing devices, entertainment systems, game systems, laptops, tablets, mobile devices, and the like.

Communication links 125 represent wired links or shared media links (e.g., wireless links, PLC links, etc.) where certain devices/nodes (e.g., routers, servers, switches, client devices, etc.) may communicate with other nodes, based on distance, signal strength, current operational status, location, etc. Those skilled in the art will understand that any number of nodes, devices, links, etc. may be used in the communication networks shown, and further the view illustrated by FIG. 1 is for purposes of discussion, not limitation.

Data packets 140 represent network traffic/messages which are exchanged between networks and network devices using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the devices or nodes interact with each other. Further, various protocols may support one or more media content formats and data, such Advanced Television Systems Committee (ATSC) formats, Advanced Video Coding (AVC) data, Moving Picture Experts Group (MPEG) data, and the like.

In addition, FIG. 1 also includes an integrated media system 200, shown by an integrated media device coupled and a routing device. Integrated media system 200 connects to OTT network 105 and OTA network 110 and forms LAN 115 (over which client devices 120 communicate). Operatively, integrated media system 200 manages and integrates subscriber media content (e.g., from OTT network 105) and local media content (e.g., from OTA network 110) and provides access to such media content to one or more client devices 120 over LAN 115.

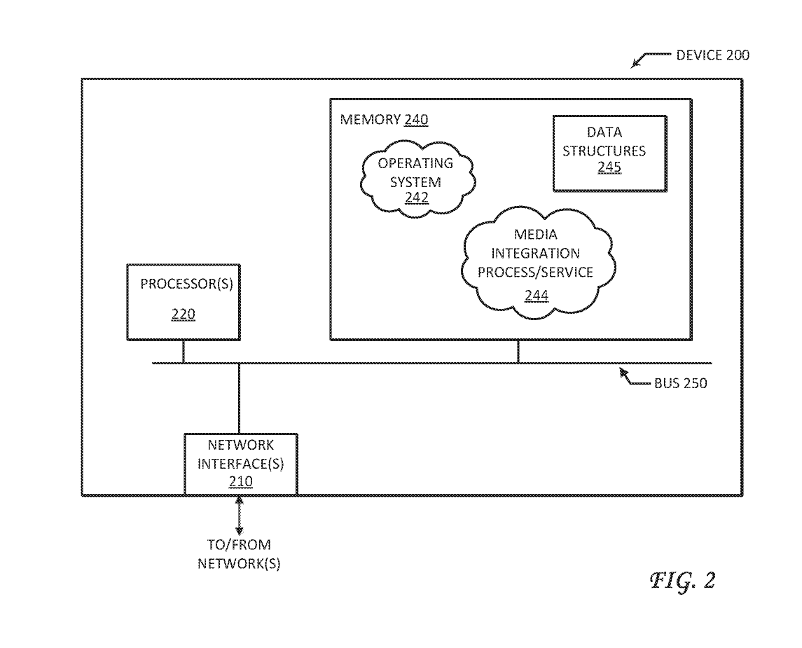

FIG. 2 illustrates a block diagram of an example integrated media system/device 200. As shown, device 200 includes one or more network interfaces 210 (e.g., transceivers, antennae, etc.), at least one processor 220, and a memory 240 interconnected by a system bus 250.

Network interface(s) 210 contain the mechanical, electrical, and signaling circuitry for communicating data over links coupled to one or more networks shown in FIG. 1. Network interfaces 210 are configured to transmit and/or receive data using a variety of different communication protocols, as will be understood by those skilled in the art.

Memory 240 comprises a plurality of storage locations that are addressable by processor 220 for storing software programs and data structures associated with the embodiments described herein. For example, memory 240 can include a tangible (non-transitory) computer-readable medium, as is appreciated by those skilled in the art.

Processor 220 may comprise necessary components, elements, or logic adapted to execute the software programs and manipulate data structures 245, which are stored in memory 240. An operating system 242, portions of which are typically resident in memory 240, and is executed by processor 220 to functionally organizes the device by, inter alia, invoking operations in support of software processes and/or services executing on the device. These software processes and/or services may comprise an illustrative “media integration” process/service 244. Note that while process/service 244 is shown in centralized memory 240, the process/service may be configured to operate in a distributed communication network.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes. For example, processor 220 can include one or more programmable processors, e.g., microprocessors or microcontrollers, or fixed-logic processors. In the case of a programmable processor, any associated memory, e.g., memory 240, may be any type of tangible processor readable memory, e.g., random access, read-only, etc., that is encoded with or stores instructions that can implement program modules, e.g., a module having spectator channel process 244 encoded thereon. Processor 220 can also include a fixed-logic processing device, such as an application specific integrated circuit (ASIC) or a digital signal processor that is configured with firmware comprised of instructions or logic that can cause the processor to perform the functions described herein. Thus, program modules may be encoded in one or more tangible computer readable storage media for execution, such as with fixed logic or programmable logic, e.g., software/computer instructions executed by a processor, and any processor may be a programmable processor, programmable digital logic, e.g., field programmable gate array, or an ASIC that comprises fixed digital logic, or a combination thereof. In general, any process logic may be embodied in a processor or computer readable medium that is encoded with instructions for execution by the processor that, when executed by the processor, are operable to cause the processor to perform the functions described herein.

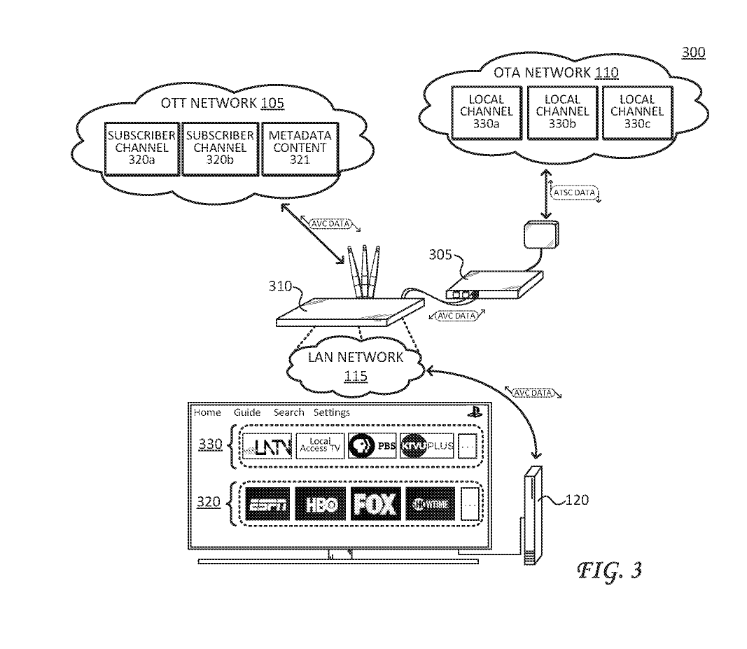

FIG. 3 illustrates a block diagram of an integrated media system 300, particularly showing an integrated media device 305 coupled to a local access network (LAN) router device 310. As discussed above, integrated media system 200 illustrated in FIG. 1 (and described in FIG. 2), may comprise integrated media device 305 and LAN device 310 (e.g., a router).

As illustrated, integrated media system 300 includes OTT network 105 (e.g., the Internet), which hosts online media content such as OTT content, including, for example, subscriber content, represented by “subscriber channels” 320a, 320b (collectively, subscriber channels 320) and metadata content 321. Notably, the OTT content may be transmitted to LAN device 310 over OTT network 105 as AVC data, as is appreciated by those skilled in the art.

OTA network 110 hosts over-the-air content, which includes, for example, local content associated with respective local channels, represented by “local channels” 330a, 330b, 330c (collectively, local channels 330). In operation, integrated media device 305 receives local content (e.g., ATSC data) using an antenna, transcodes the local content from ATSC data to AVC data (e.g., H.264/MPEG-4 AVC) to form streaming content which can be hosted over LAN 115—here, integrated media device 305 is directly coupled to LAN device 310 using a hardwire communication link for broadcasting/hosting streaming content over LAN 115. However, it is also appreciated that integrated media device 305 may be wirelessly coupled to one or more devices in LAN 115, as is appreciated by those skilled in the art.

With respect to user perspective, a user interacts with a client device—here, client device 120—which is coupled to a display (e.g., TV display). Client device 120, operatively provides streaming content (e.g., media content for local and subscriber channels) to the display. In particular, client device 120 receives local content associated with local channels 330, subscriber content associated with subscriber channels 320, and metadata content 321 over LAN 115. Client device 120 communicates with integration device 305 to determine local channel availability—here, local channels 330, including local channels 330a, 330b, 330c. In some embodiments, however, client device 120 may determine local channel availability based on content received from OTT network 105 (or from other networks (not shown)) and/or the local channel availability may be determined by integration device 305 and sent to client device 120 over LAN 115.

Client device further matches metadata content 321 (e.g., from OTT network 105) for respective local channels 330. For example, metadata content 321 can include content from third party media service providers such as Tribune Media Services (TMS) providers, Gemstar TVGuide providers, and the like. In some embodiments, client device 120 may receive metadata content 321 for local channels 330 from OTA network 110 (or from other networks (not shown)).

Client device 120 provides metadata content 321 for local channels 330 and subscriber channels 320 to the display (as shown), and the user may select one or more channels to watch. Once selected, client device 120 sends a request for the corresponding local/subscriber channel (and/or content) over LAN 115. If the request corresponds to subscriber channels 320, client device 120 requests subscriber content from OTT network 105. If the request corresponds to local channels 330, client device 120 requests local content from OTA network 110 from integration device 305, which (in turn) hosts or broadcasts the local content over LAN 115, as discussed above.

While certain devices shown in FIG. 3 are illustrated as distinct and independent—e.g., client device 120, integrated media device 305, and LAN device 310—it is appreciated that such devices and operations performed by such devices may collectively describe a integrated media platform. Further, the above discussed operations by the devices may be readily incorporated or combined into a single device/system or, alternatively, such operations reside in a distributed computing system (e.g., cloud-based computing systems).

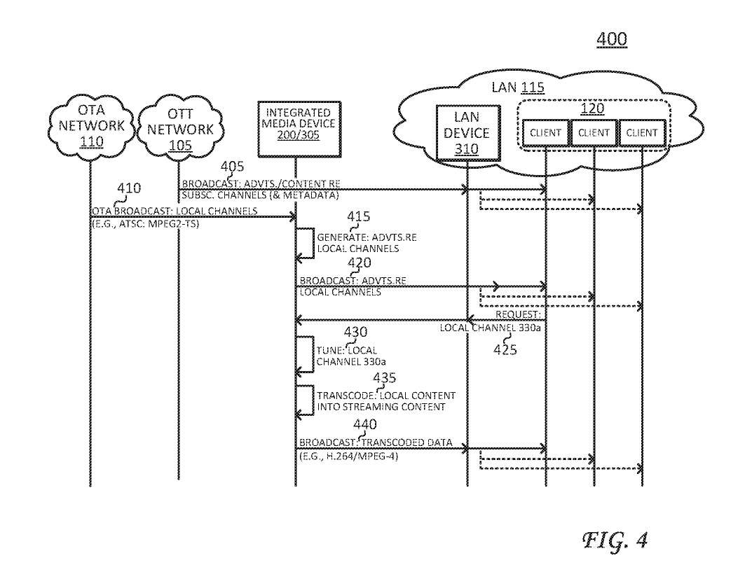

FIG. 4 illustrates an exemplary signaling diagram 400, which describes the above operations for devices in integrated media system 300. As shown, one or more client devices 120 receive subscriber channels (and metadata) content from a broadcast signal 405 over LAN 115 (e.g., from content providers in OTT network 105). In particular, client devices 120 communicate with content providers in OTT network 105 through LAN device 310 (over LAN 115). Here, the broadcast signal 410 includes advertisements, content, and metadata content for subscriber channels (e.g., subscriber channels 320).

In addition, integrated media device 305 receives an OTA broadcast signal 405 from OTA content providers in OTA network 110. The broadcast signal includes local channel content (e.g., ATSC: MPEG2-TS data). Integrated media device 305 can determine local channel availability based on this broadcast signal, and may generate, at signal 415, advertisements for available local channels. These advertisements are further sent, at signal 420, to LAN device 310 for broadcast over LAN 115 to one or more client devices 120.

As discussed, client devices 120 compile and present metadata content for subscriber channels as well as local channels on a display. A user selects one of the channels for viewing, which causes the client device to send a request for content, at signal 425—here, signal 425 requests content for local channel 330a. Signal 425 is sent over LAN 115 to LAN device 310, which forwards signal 425 to integrated media device 305. Integrated media device 305 receives the request and tunes, at signal 430, one or more of its network interfaces (e.g., an antennae, etc.) to local channel 330a to receive corresponding local content. Integrated media device 305 receives the corresponding local content and transcodes, at signal 435, the corresponding local content into streaming content (e.g., ATSC: MPEG2-TS data into H.264/MPEG-4 AVC data, etc.). Integrated media device 305 further sends the transcoded data (e.g., streaming content) at signal 440 to LAN device 310 for broadcast to one or more client devices 120. Notably, any device connected to LAN device 310 over LAN 115 may receive the transcoded data or streaming content. Further, it is appreciated integrated media device 305 may have more than one network interface or antenna, which allows integrated media device 305 to tune to more than one local channel and provide transcoded data or streaming content regarding the same.

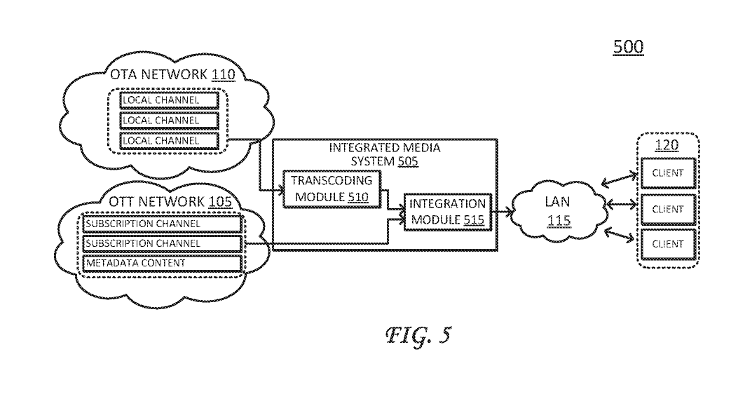

FIG. 5 illustrates another embodiment of an integrated media platform 500, which may represent operations or functions of one or more devices shown in FIG. 3. For example, integrated media system 500 may combine certain functionality of client device 120, integrated media device 305, and/or LAN device 310. Here, integrated media platform 500 includes an integrated media system 505, which provides a transcoding module 510 and an integration module 515. In operation, integrated media system 505 receives local content, which may include advertisements, media content, metadata, etc., for local channels, transcodes the local content into streaming content, and sends the streaming content to integration module 515. Integration module 515 also receives streaming content regarding subscriber channels, which may include advertisements, media content, metadata, etc., integrates or otherwise combines the streaming content corresponding to local channels and subscriber channels into a broadcast stream, and broadcasts the broadcast stream to clients 120 over LAN 115.

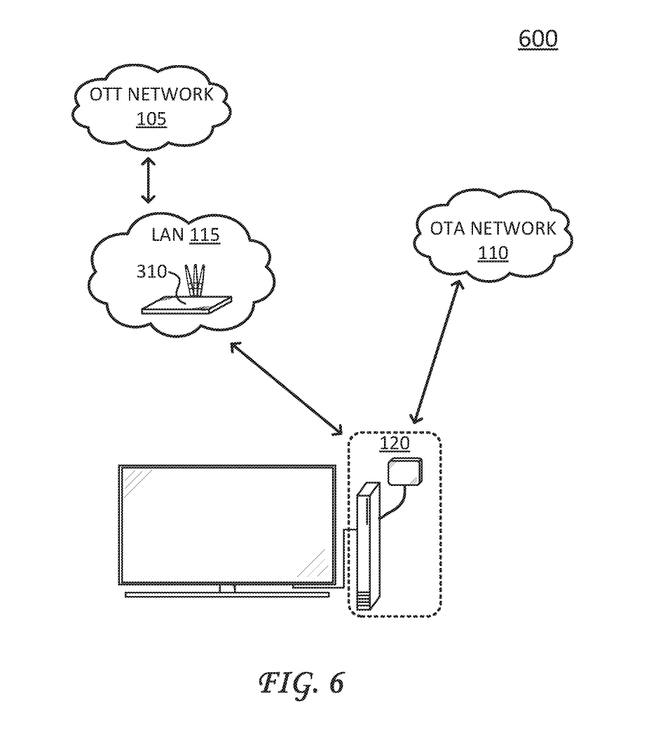

FIG. 6 illustrates a schematic diagram of an integrated media system 600, according to another embodiment of this disclosure. Here, client device 120 combines certain hardware of integrated media device 305 (e.g., an antenna) and performs the same operations of integrated media device 305, as discussed above. For example, here, client device 120 directly receives local channel content over OTA network 110 and further receives subscriber channel content from OTT network over LAN 115.

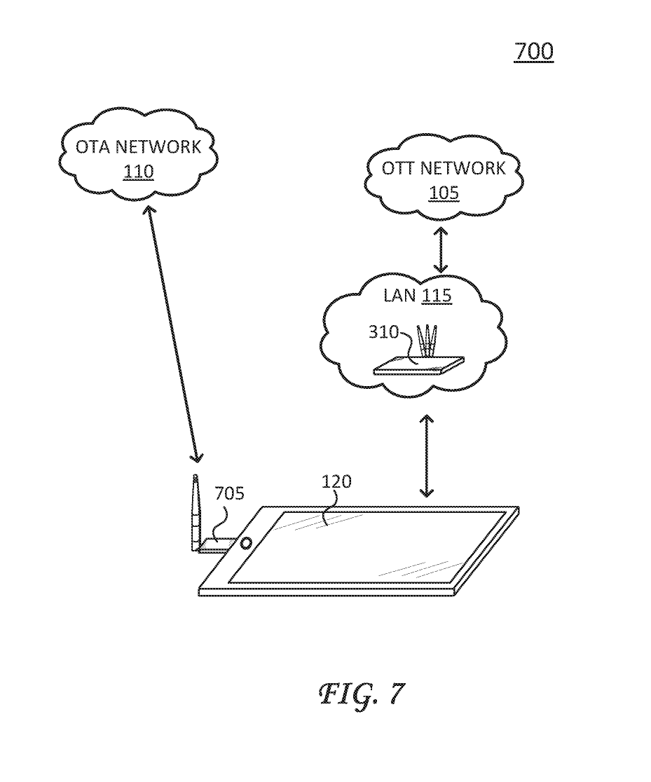

FIG. 7 illustrates a schematic diagram of an integrated media system 700, according to another embodiment of this disclosure. Here, an integrated media device 705 includes a small form factor, which is directly coupled to a client device 120 (e.g., a tablet device) having a display. Integrated media device 705 performs the same operations of integrated media device 305, discussed above, and receives local channel content over OTA network 110 directly. Client device 120 may also include additional network interfaces (e.g., hardware and software) for receiving subscriber channel content from OTT network over LAN 115.

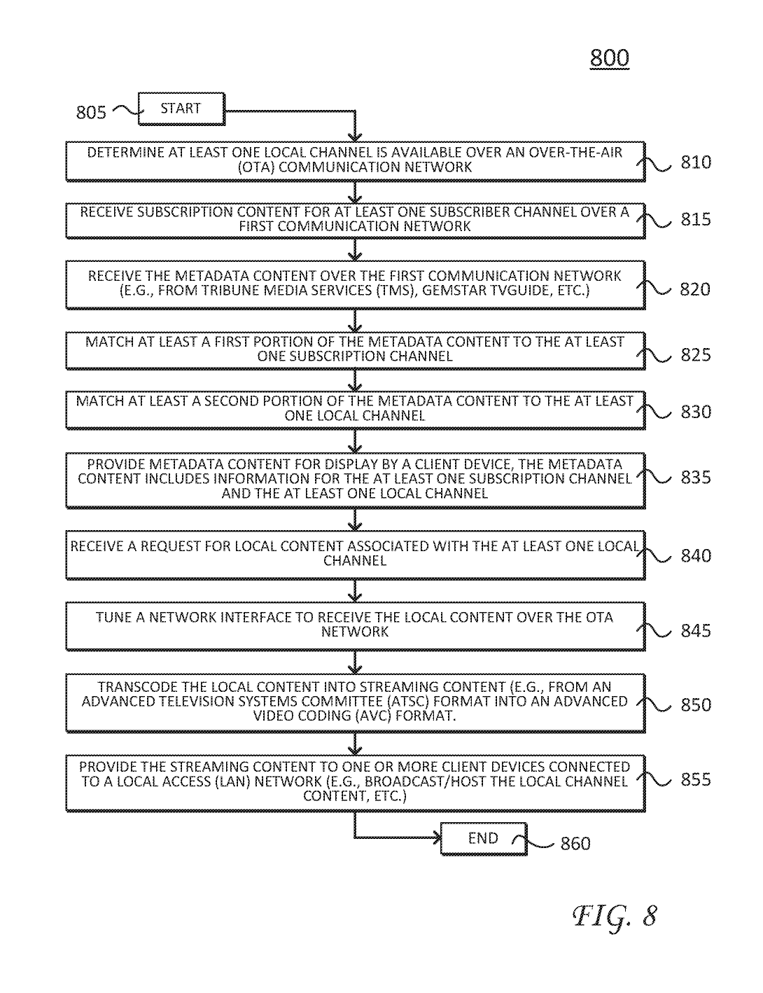

FIG. 8 illustrates an example simplified procedure 800 for integrating local and subscriber media content, particularly from the view of an integrated media system or platform (e.g., systems/devices/platforms 200, 305, 500, 505, 705, etc.) Procedure 800 begins at step 805 and continues to step 810, where, as described in greater detail above, the integrated media system determines at least one local channel is available over an over-the-air (OTA) communication network (e.g., OTA network 110). The integrated media system also receives, at step 815, subscriber content (e.g., Advanced Video Coding (AVC) data) from, for example, over-the-top content providers over a first communication network (e.g., the Internet, or OTT network 105). The subscriber content can include, for example, media content for a subscriber channel as well as metadata content (step 820) for subscriber channels and/or local channels). With respect to the metadata content, received at step 820, the integrated media system may receive the metadata content from, for example, metadata collectors/aggregators such as from Tribune Media Services (TMS), Gemstar TVGuide, and the like.

The integrated media system further matches, at step 825, at least a first portion of the metadata content to the at least one subscriber channel, and matches, at step 830 at least a second portion of the metadata content to the at least one local channel. For example, as discussed above (and shown in FIG. 3), the metadata content for both local and subscriber channels may be aggregated or compiled and provided, at step 835, to a display by a client device (e.g., metadata content regarding available local channels 330 and subscriber channels 320 are shown in FIG. 3).

As discussed, a user selects a subscriber channel or a local channel for viewing. Here, step 840, indicates the user selects one of the local channels for viewing, which corresponds to the integrated media system receiving a request for local content associated with the selected local channel. The integrated media system further tunes, at step 845, one of its network interfaces (e.g., an antenna) to receive the local content over the OTA network.

Typically, the local content is broadcast over the OTA network as Advanced Television Systems Committee (ATSC) data and, as discussed, the integrated media system transcodes, at step 850, the local content into streaming content (e.g., from Advanced Television Systems Committee (ATSC) data to Advanced Video Coding (AVC) data), and provides, at step 855, the streaming content to one or more client devices connected over a local network (e.g., a local access network such as LAN 110). For example, the integrated media system and/or a LAN device (e.g., LAN device 310) can host, broadcast, or otherwise transmit the streaming content to client devices connected to the LAN. Notably, the streaming content may be sent over the LAN using, for example, HTTP Live Streaming (HLS) protocols, a Dynamic Adaptive Streaming over HTTP (DASH) protocols, or the like.

Procedure 800 subsequently ends at step 860, but may continue on to step 810 where the integrated media system determines one or more local channel are availabe over the OTA network, as discussed above. Collectively, the steps in procedure 800 describe techniques to integrate and stream local content and subscriber content over a private network (e.g., a LAN), which obviates conventional choices consumers make between local media content and subscriber media content when transitioning from cable TV service providers to online service providers.

It should be noted that certain steps within procedures 800 may be optional, and further, the steps shown in FIG. 8 are merely examples for illustration. Certain other steps may be included or excluded as desired. Further, while a particular order of the steps is shown and executed from the perspective of a particular device or system, this ordering is merely illustrative, and any suitable arrangement of the steps and/or any number of systems, platforms, or devices may be utilized without departing from the scope of the embodiments herein.

The techniques described herein, therefore, integrate subscriber content (e.g., data corresponding to subscriber channels) available from OTT service providers and local content (e.g., data corresponding to local channels) available over OTA networks in one streaming service/platform. In this fashion, the techniques herein provide a seamless viewing experience where a user may select subscriber channels or local channels.

While there have been shown and described illustrative embodiments that integrate local content and subscriber content, it is to be understood that various other adaptations and modifications may be made within the spirit and scope of the embodiments herein. For example, the embodiments have been shown and described herein with relation to certain systems, platforms, devices, and modules performing specific operations. However, the embodiments in their broader sense are not as limited, and may, in fact, such operations and similar functionality may be performed by any combination of the devices shown and described.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories such as disks, CDs, RAM, and EEPROM having program instructions executing on a computer, hardware, firmware, or a combination thereof.

Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code.

Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on.

Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures.

Accordingly this description is to be taken only by way of example and not to otherwise limit the scope of the embodiments herein. Therefore, it is the object of the appended claims to cover all such variations and modifications as come within the true spirit and scope of the embodiments herein.

1. A method, comprising:
receiving, by an integrated media device, metadata content over a first communication network, the metadata content including information for at least one subscriber channel and at least one local channel;
determining, by the integrated media device, the at least one local channel is available over an over-the-air (OTA) communication network;
receiving, by the integrated media device, subscriber content for at least one subscriber channel over the first communication network;
providing the metadata content for display by a client device;
receiving, by the integrated media device, a request for local content associated with the at least one local channel;
tuning, by the integrated media device, an antenna of the integrated media device to receive the local content over the OTA network;
transcoding, by the integrated media device, the local content into streaming content; and
providing the local content to one or more client devices connected to a local access network.

2. The method of claim 1, wherein providing the local content further comprises broadcasting the local content over the LAN network using at least one of a HTTP Live Streaming protocol or a Dynamic Adaptive Streaming over HTTP (DASH) protocol.

3. The method of claim 1, wherein providing the local content further comprises hosting, by the integrated media device, the local content for broadcast over the LAN network.

4. The method of claim 1, wherein the OTA communication network is different than the first communication network, the method further comprising:
matching at least a first portion of the metadata content to the at least one subscriber channel; and
matching at least a second portion of the metadata content to the at least one local channel.

5. The method of claim 4, wherein receiving the metadata content over the first communication network further comprises receiving the metadata content from at least one of a Tribune Media Services (TMS) provider or a Gemstar TVGuide provider.

6. The method of claim 1, wherein transcoding the local content into streaming content further comprises transcoding the local content from Advanced Television Systems Committee (ATSC) data into Advanced Video Coding (AVC) data.

7. The method of claim 1, wherein the metadata content and the subscriber content include Advanced Video Coding (AVC) data.

8. The method of claim 1, wherein providing the metadata content further comprises, providing Advanced Video Coding (AVC) data, and wherein the streaming content includes the AVC data.

9. An integrated media system, comprising:
a network interface to communicate over one or more communication networks;
a processor coupled to the network interface and adapted to execute one or more processes; and
a memory configured to store a process executable by the processor, the process when executed operable to:
receive metadata content over a first communication network, the metadata content including information for at least one subscriber channel and at least one local channel;
determine the at least one local channel is available over an over-the-air (OTA) communication network;
receive subscriber content for at least one subscriber channel over the first communication network;
provide the metadata content for display by a client device;
receive a request for local content associated with the at least one local channel;
tune the network interface to receive the local content over the OTA network;
transcode the local content into streaming content; and
provide the local content to one or more client devices connected to a local access network.

10. The integrated media system of claim 9, wherein the process, when executed by the processor to provide the local content, is further operable to broadcast the local content over the LAN network using at least one of a HTTP Live Streaming protocol or a Dynamic Adaptive Streaming over HTTP (DASH) protocol.

11. The integrated media system of claim 9, wherein the process, when executed by the processor to provide the local content, is further operable to host the local content for broadcast over the LAN network.

12. The integrated media system of claim 9, wherein the OTA communication network is different than the first communication network, wherein the process is further operable to:
match at least a first portion of the metadata content to the at least one subscriber channel; and
match at least a second portion of the metadata content to the at least one local channel.

13. The integrated media system of claim 12, wherein the process, when executed by the processor to receive the metadata content over the first communication network, is further operable to receive the metadata content from at least one of a Tribune Media Services (TMS) provider or a Gemstar TVGuide provider.

14. The integrated media system of claim 9 wherein the process, when executed by the processor to transcode the local content into streaming content, is further operable to transcode the local content from Advanced Television Systems Committee (ATSC) data into Advanced Video Coding (AVC) data.

15. The integrated media system of claim 9, wherein the metadata content and the subscriber content include Advanced Video Coding (AVC) data.

16. The integrated media system of claim 9, wherein the process, when executed by the processor to provide the metadata content, is further operable to provide Advanced Video Coding (AVC) data, and wherein the streaming content includes the AVC data.

17. A tangible, non-transitory, computer-readable media having software encoded thereon, the software, when executed by a processor, is operable to:
receive metadata content over a first communication network, the metadata content including information for at least one subscriber channel and at least one local channel;
determine the at least one local channel is available over an over-the-air (OTA) communication network;
receive subscriber content for at least one subscriber channel over a first communication network;
provide the metadata content for display by a client device;
receive a request for local content associated with the at least one local channel;
tune a network interface to receive the local content over the OTA network;
transcode the local content into streaming content; and
provide the local content to one or more client devices connected to a local access network.

18. The tangible, non-transitory, computer-readable media of claim 17, wherein the software, when executed to provide the local content, is further operable to broadcast the local content over the LAN network using at least one of a HTTP Live Streaming protocol or a Dynamic Adaptive Streaming over HTTP (DASH) protocol.

19. The tangible, non-transitory, computer-readable media of claim 17, wherein the OTA communication network is different than the first communication network, wherein the software, when executed, is further operable to:
match at least a first portion of the metadata content to the at least one subscriber channel; and
match at least a second portion of the metadata content to the at least one local channel.

20. The tangible, non-transitory, computer-readable media of claim 17, wherein the software, when executed to transcode the local content into streaming content, is further operable to transcode the local content from Advanced Television Systems Committee (ATSC) data into Advanced Video Coding (AVC) data.

21. The method of claim 1, comprising:
receiving, by the integrated media device, advertiser content over the OTA network; and
transcoding, by the integrated media device, the advertiser content into the streaming content.

22. A method for integrating and streaming media content from multiple communication networks via an integrated media device, the method comprising:
detecting, by an integrated media device, that at least one local channel is available over an over-the-air (OTA) communication network;
receiving, by the integrated media device, subscriber content for at least one subscriber channel over a first communication network;
providing metadata content for display by a client device, the metadata content includes information for the at least one subscriber channel and the at least one local channel;
receiving, by the integrated media device, a request for user access to local content associated with the at least one local channel;
tuning, by the integrated media device, an antenna of the integrated media device to receive the requested local content over the OTA communication network;
transcoding, by the integrated media device, the requested local content into streaming content;
combining the streaming content with the subscriber content for the at least one subscriber channel; and
transmitting the combined streaming content and the subscriber content to one or more client devices connected to a local access (LAN) network.
